(19) United States
(12) Patent Application Publication
(10) Pub. No.: US 2016/0153799 A1
(43) Pub. Date: Jun. 2, 2016

(54) Electronic Device

(71) Applicant: Alpine Electronics, Inc., Tokyo (JP)

(72) Inventor: Satoshi Kodama, Iwaki (JP)

(21) Appl. No.: 14/943,994

(22) Filed: Nov. 17, 2015

(30) Foreign Application Priority Data
Dec. 2, 2014 (JP) 2014-243760

(51) Int. Cl. G01C 21/36

(52) U.S. Cl. CPC G01C 21/36

(57) ABSTRACT

An electronic device may include a navigation unit configured to obtain navigation information about a vehicle in which the electronic device is mounted, a video reproducing unit configured to reproduce a video from video information obtained from a video source, a display operating unit configured to display an image based on the navigation information obtained by the navigation unit or a video reproduced by the video reproducing unit and to accept an input that is made by touching a predetermined area with an operating body, and a display control unit configured to display operation buttons on the display operating unit when the video reproduced by the video reproducing unit is displayed on the display operating unit, the operation buttons being used to perform operations corresponding to a navigation mode, which operates according to the navigation information.

### RELATED APPLICATIONS

The present application claims priority to Japanese Patent Application Serial Number 2014-243760, filed Dec. 2, 2014, the entirety of which is hereby incorporated by reference.

### BACKGROUND OF THE INVENTION

1. Field of the Invention

The present disclosure relates to an electronic device having a display operating unit that displays an image based on navigation information or a video reproduced by a reproducing unit and accepts an input made by touching with an operating body.

2. Description of the Related Art

A vehicle-mounted electronic device has a navigation mode in which the vehicle is navigated, an audiovisual (AV) mode in which a video is displayed, and other various functional modes. While, for example, this type of electronic device is traveling, it enables the navigation mode, in which a vehicle position 101, a route 103 to a target facility 102, and other information are displayed on a map displayed on a display screen 100, as illustrated in FIG. 4A. While the electronic device is stopping, it enables a television (TV) reception mode in which a TV broadcast is viewed or the AV mode, in which a video or the like is viewed by use of a digital versatile disc (DVD) or another medium, as illustrated in FIG. 4B.

A self-driving technology by which a vehicle is automatically driven to a destination or the like is being developed. In this type of self-driving technology, since a vehicle is automatically driven along a route, while in driving, it may be possible to enable the navigation mode in a background and view a TV broadcast or a DVD-based video displayed on a screen. While a video screen is being viewed with self-driving set, a need may arise to search for a facility, such as, for example, a rest facility or an oil supply facility, at which to make a stop in the course of driving. In this case, it is possible to make a switchover to the navigation mode through an operation, display an operation menu or the like on the screen, search for a facility, change a transit point, and perform other operations (see, for example, Japanese Unexamined Patent Application Publication No. 7-271824).

### SUMMARY OF THE INVENTION

Complex, time-consuming, and inconvienient operations are often required to make a switchover from a screen on which a video or the like is being viewed to a navigation screen, to search for a desired facility or the like, and to change a setting relating to a transit point and/or to change other settings as described above.

The present disclosure addresses the above situation with the object of providing an electronic device that enables operations corresponding to the navigation mode to be easily performed while a TV mode or AV mode in which a video or the like is displayed is in progress.

To addresses the above problem, an electronic device may include a navigation unit configured to obtain navigation information about a vehicle in which the electronic device is mounted, a video reproducing unit configured to reproduce a video from video information obtained from a video source, a display operating unit configured to display an image based on the navigation information obtained by the navigation unit or a video reproduced by the video reproducing unit and configured to accept an input that is made by touching a predetermined area with an operating body, and a display control unit configured to display operation buttons on the display operating unit when the video reproduced by the video reproducing unit is displayed on the display operating unit, the operation buttons being used to perform operations corresponding to a navigation mode, which operates according to the navigation information.

With this structure, when a video reproduced by the video reproducing unit is displayed on the display operating unit, the display control unit is configured to display, on the display operating unit, the operation buttons used to perform operations corresponding to navigation functions that operate according to the navigation information. Because of this, it is possible to easily perform operations corresponding to the navigation mode by touching the operation buttons, without having to perform an operation to switch to the navigation mode.

With the electronic device, when the video reproduced by the video reproducing unit is displayed on the display operating unit, the navigation mode may operate in a background.

With this structure, when a video reproduced by the video reproducing unit is displayed on the display operating unit, since the navigation mode is operating in the background, it is possible to quickly perform operations corresponding to the navigation mode by operating the operation buttons.

In some implementations of the electronic device, the video reproducing unit may be structured as an AV unit that is configured to reproduce a video from video information stored in a compact disc (CD) or a DVD, which is a storage medium, or as a television broadcast receiver that is configured to receive a television broadcast and reproduce a video.

With this structure, it is possible to quickly perform operations corresponding to the navigation mode by operating the operation buttons while a video reproduced from a CD or DVD by the AV unit is being viewed or a video reproduced by the television broadcast receiver is being viewed.

In some implementations of the electronic device, the operation buttons may be icons that activate predetermined programs executed under the navigation functions.

With this structure, when a video reproduced by the video reproducing unit is displayed on the display operating unit, the operation buttons that perform operations corresponding to the navigation mode, which operates according to the navigation information, may be icons that activate the predetermined programs, so it is possible to easily perform, for example, a search in the navigation mode. For example, it is possible to search for a facility at which to make a stop or another location in the vicinity of the travel route, to change a transit point, and to perform other operations, without having to perform an operation to switch to the navigation mode.

The electronic device may further include a proximity sensor that detects the proximity of the operating body to the display operating unit. When the proximity sensor detects the proximity of the operating body to within a predetermined range on the display operating unit, the display control unit displays the operation buttons on the display operating unit.

With this structure, when the proximity sensor detects the proximity of the operating body, which is a finger, a touch pen, or the like, to the display operating unit, the operation buttons are displayed. Therefore, it is possible to suppress the displayed operation buttons from impairing the viewing of a video when compared with a case in which the operation buttons are left displayed.

With the electronic device, the display control unit may magnify operation buttons that are frequently operated and may display the magnified operation buttons.

With this structure, it is possible to make a touch of frequently operated operation buttons reliable. Since this structure also contributes to the prevention of an operation mistake, convenience is improved. If, for example, icons (operation buttons) to search for rest facilities, washrooms, and the like at which a stop needs to be frequently made during driving are displayed so as to be larger than the other operation buttons, convenience is improved. The frequency at which each operation button will be operated can be determined according to, for example, the number of times the operation button was operated within a predetermined time in the past. It is also possible to display a desired operation button (such as an icon) so as to be larger than the other operation buttons according to a setting made by a user such as an occupant, regardless of the usage frequency of the operation button.

With implementations of the electronic device according to the present disclosure, after an operation button corresponding to the navigation mode has been operated by being touched with the operating body, the display control unit may hide the operation button from the display operating unit until a predetermined time elapses.

With this structure, if it is predicted that an operation button that has been touched will not be touched again until a predetermined time elapses, when the operation button is hidden until the predetermined time elapses, another operation button can be displayed instead, making it possible to improve convenience. For example, after an icon to search for, for example, rest facilities, washrooms, or the like had been touched and a stop has been made, the search icon may not be thought to be searched for again within the predetermined time, so it is possible to hide the search icon for a short time and display another icon instead during that time, making it possible to improve convenience.

### BRIEF DESCRIPTION OF THE DRAWINGS

FIG. 1 is a block diagram of a vehicle-mounted device, which is an electronic device;

FIG. 2 is a flowchart illustrating an operation procedure for the vehicle-mounted device, which is an electronic device;

FIG. 3 schematically illustrates a video screen displayed on a display unit of the vehicle-mounted device, which is an electronic device;

FIG. 4A schematically illustrates a navigation-mode image screen displayed on a display unit of a conventional vehicle-mounted device; and

FIG. 4B schematically illustrates a video screen, for a TV broadcast, that is displayed on the display unit of the conventional vehicle-mounted device.

### DETAILED DESCRIPTION OF THE DRAWINGS

An embodiment of the present invention will be described with reference to the drawings.

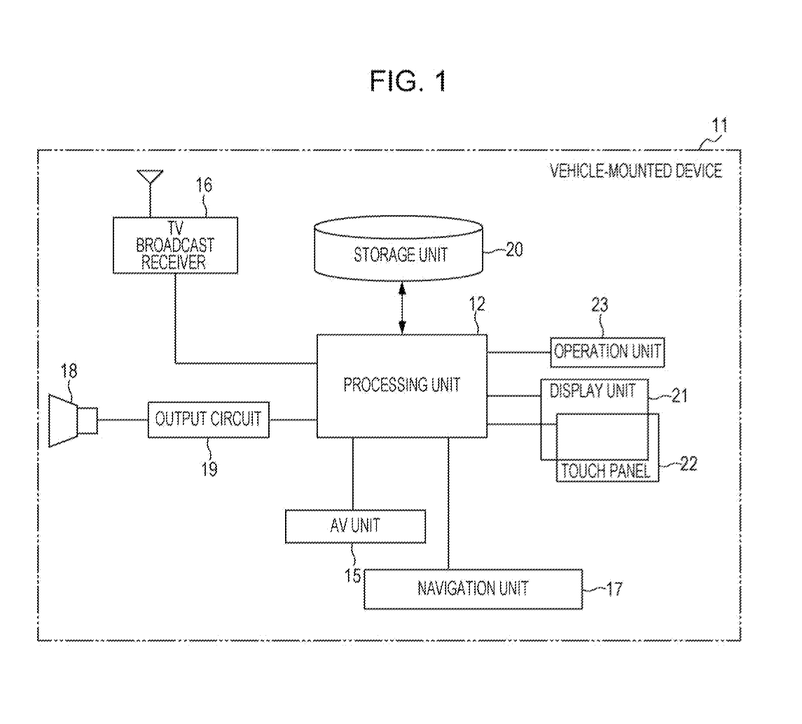

A vehicle-mounted device, which is an electronic device, is structured as illustrated in FIG. 1.

As illustrated in FIG. 1, the vehicle-mounted device 11 includes a processing unit 12 formed by using a computer unit (such as, for example, a central processing unit (CPU) or a microprocessing unit (MPU)). An audiovisual (AV) unit 15 that can reproduce voice and videos recorded on various sound sources and video sources (such as, for example, CDs and DVDs), a TV broadcast receiver 16 that can receive a digital TV broadcast or the like and can reproduce voice and a video, and a navigation unit 17 that can navigate the vehicle in which the vehicle-mounted device 11 is mounted are connected to the processing unit 12. A speaker 18 is also connected to the processing unit 12 through an output circuit 19. Thus, voice signals involved in processing by the AV unit 15, TV broadcast receiver 16, and navigation unit 17 can be output as voice from the speaker 18 by the output circuit 19.

Also connected to the processing unit 12 are a storage unit 20 (such as, for example, a hard disk memory or a flash memory) that can store music information, map information, and other various types of information that are used in the AV unit 15 and navigation unit 17 and can also store video information and voice information received by the TV broadcast receiver 16, a display unit 21, formed by using a liquid crystal display (LCD) and the like, that displays a video and the like involved in various types of processing, a touch panel 22, placed on the display unit 21, that can enter a necessary command made by being touched with an operating body (such as, for example, a finger or a touch pen), and an operation unit 23 that can enter a command made by operating a physical key such as a pushbutton. The AV unit 15 and TV broadcast receiver 16 described above constitute a video reproducing unit. The display unit 21 and touch panel 22 constitute a display operating unit.

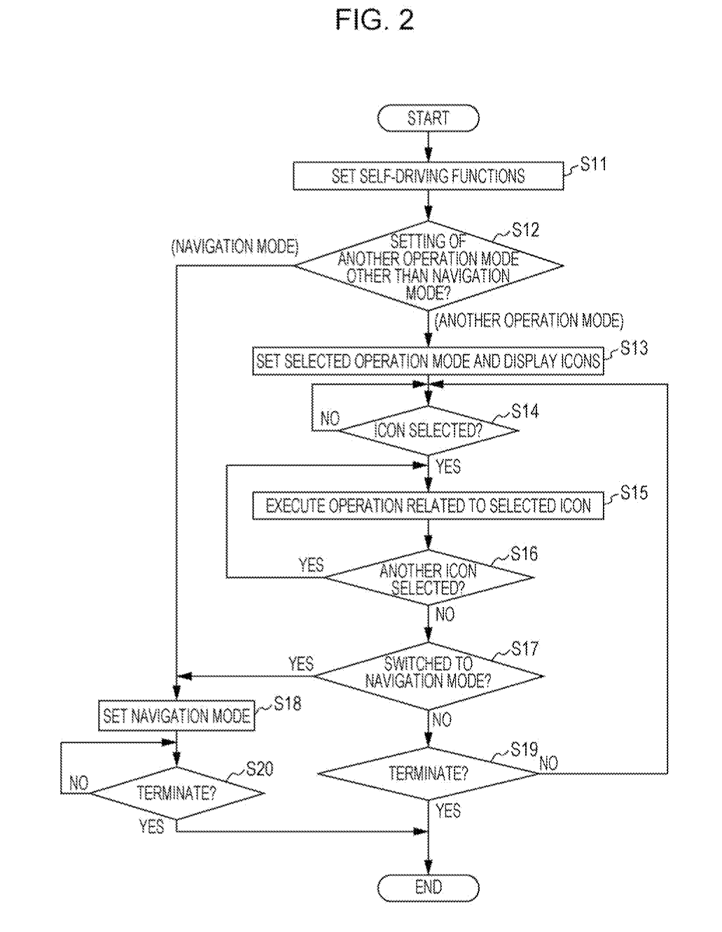

In the above vehicle-mounted device 11 used as an electronic device, processing is performed according to an operation procedure as illustrated in FIG. 2. Although, in this embodiment, the operation procedure for the vehicle-mounted device 11 will be described for a case in which the vehicle is self-driven, the use of the operation procedure is not limited to self-driving.

In FIG. 2, the processing unit 12 sets self-driving functions in which a destination, transit points, a route, and the like are specified according to choices made by an occupant in the vehicle (not illustrated) (S11). Thus, the occupant does not need to perform vehicle operations such as steering operations until the vehicle arrives at the destination. With the self-driving functions set, the processing unit 12 places the vehicle-mounted device 11 in the navigation mode in which the vehicle in which the vehicle-mounted device 11 is mounted can be guided to, for example, a destination and a display can be given.

Next, the processing unit 12 asks the occupant whether to set another operation mode other than the navigation mode for the vehicle-mounted device 11 (S12). If the occupant further sets, for example, a TV broadcast viewing mode in the vehicle-mounted device 11 as an operation mode other than the navigation mode, the occupant can view a broadcast of the occupant's favorite TV program. If the occupant sets an AV viewing mode, the occupant can view, for example, a video stored in a DVD or the like. When self-driving is set, a TV broadcast or a video stored in a DVD, for example, can be viewed during driving as well. With self-driving set, therefore, another operation mode other than the navigation mode can be set in the vehicle-mounted device 11.

If only the navigation mode has been set (the navigation mode has been selected in S12), the processing unit 12 displays map information and the current position of the vehicle on a screen on the display unit 21, as described above (S18). On the screen on the display unit 21, display buttons, icons, and the like that are effected in the navigation mode to, for example, search for facilities are displayed. When any control is touched, the vehicle is guided to, for example, a facility located in the vicinity by self-driving. Alternatively, an operation menu is displayed, enabling the occupant to search for a desired facility.

If another operation mode (TV broadcast viewing mode, AV viewing mode, or the like) is selected, the processing unit 12 sets the selected other operation mode, after which a TV broadcast, a video stored in a DVD, or the like is displayed on the screen on the display unit 21. In addition, icons are displayed on the screen as operation buttons with which operations corresponding to the navigation mode are performed (S13). With the other operation mode set, the navigation mode is operated in the background.

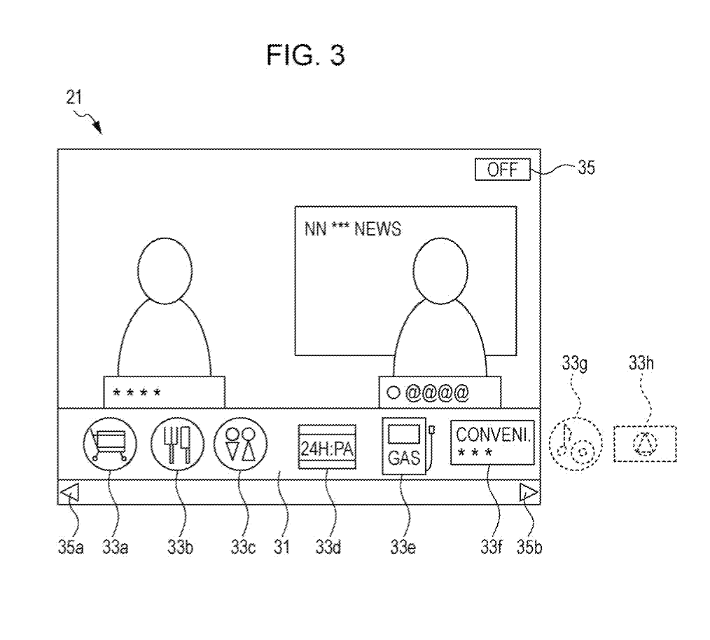

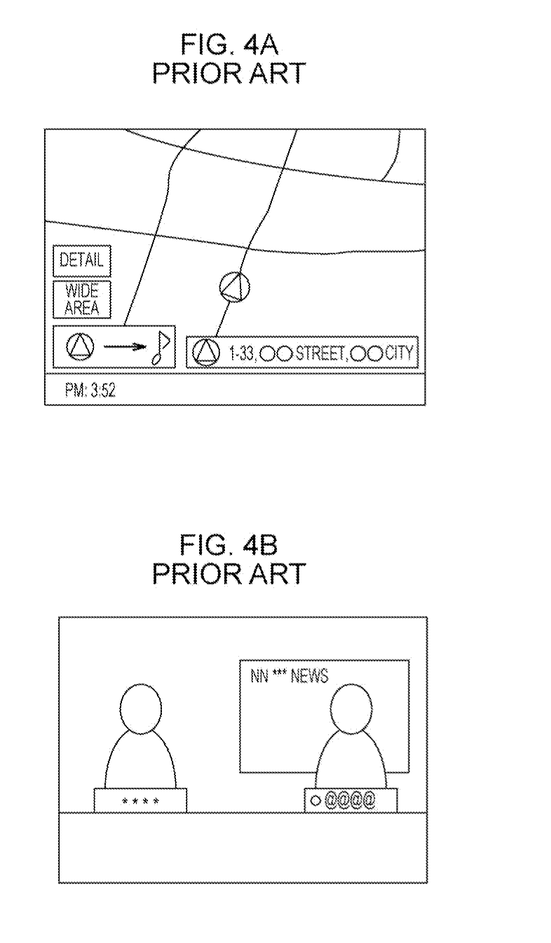

FIG. 3 illustrates a screen that is displayed on the display unit 21 when another operation mode (TV broadcast viewing mode, AV viewing mode, or the like) other than the navigation mode is set together with a self-driving setting. The screen in FIG. 3 is displayed when the TV broadcast viewing mode was selected as the other operation mode; a news program is being viewed on the screen. On the screen on the display unit 21, the news program by a TV broadcast is displayed as in a case in which the news program is viewed on a normal television set. A plurality of icons 33 (33a to 33f) are displayed as a plurality of display buttons on a zonal area 31 that extends to the right and left at the bottom of the screen on the display unit 21. Scroll buttons 35a and 35b are further displayed below the icons 33. The scroll buttons 35a and 35b display other icons 33 (33g, 33h, and so on) that are hidden from the screen by, for example, scrolling so as to be selectable.

The icons 33 are operation buttons with which operations corresponding to the navigation mode are performed. When the touch panel 22 is touched with an operating body (such as, for example, a finger or a touch pen) on an icon 33 displayed on the screen on the display unit 21, the relevant operation corresponding to the navigation mode is performed without having to perform an operation to switch to the navigation mode. The icons 33 may be left displayed while a TV broadcast is being viewed, or may be displayed only when an operating body comes close to a predetermined range on the screen. In the latter case, a proximity sensor (not illustrated) is attached in the vicinity of the vehicle-mounted device 11. When the proximity sensor detects the proximity of an operating body, the processing unit 12 can display the icons 33 in response to a detection signal from the proximity sensor (the icons 33 are displayed by the control display unit). Thus, a video can be adequately displayed on the screen except when the icons 33 need to be operated.

Each icon 33a is a display button that activates a program that searches for, for example, shopping facilities, changes a route, sets the changed route, and guides the vehicle along the route. When the icon 33a is touched, the processing unit 12 detects, under a navigation function, convenience stores, supermarkets, and the like located in the vicinity of the travelling vehicle from the map information and the like, sets the nearest shopping facility as a transit point, and changes the route so as to include the transit point, with the navigation mode placed in the background state. In addition, the icon 33a may be such that when it is touched, a menu of shopping facilities is displayed and the route is changed so that the vehicle travels via the facility selected from the displayed menu by the occupant. The displayed menu can also be set so that it includes a display field that includes a convenience store item, a supermarket item, a department store item, a specialty shop item, a load-side station (such as a Michi-no-Eki in Japan) item, and other facility items, and when a facility item is selected, the route is changed so that the vehicle travels toward the nearest facility classified into the selected facility item. The menu may also be set so that when the vehicle is within a living area, facilities at which the occupant makes a stop in daily life are preferentially displayed in the displayed menu, and when the vehicle is outside the living area, shops of well-known products, load-side stations, and the like are preferentially displayed.

The icon 33b is a display button that activates a program searching for, for example, a restaurant to take a meal and guides the vehicle to the restaurant. When the icon 33b is touched with an operating body, the processing unit 12 searches, under a navigation function, for restaurants located in the vicinity of the travelling vehicle, sets the nearest restaurant or a restaurant selected from a displayed operation menu as a transit point, and changes the route so as to include the transit point, with the navigation mode placed in the background state. In this case as well, the operation menu may also be set so that when the vehicle is within the living area, restaurants at which the occupant makes a stop in daily life are preferentially displayed in the operation menu, and when the vehicle is outside the living area, restaurants and the like that are searched for according to, for example, gourmet information stored in the storage unit 20 are preferentially displayed.

The icon 33c is a display button that, when touched while driving to make a stop for use of a washroom, activates a program searching for, under a navigation function, a washroom-equipped facility closest to the current position of the vehicle, and guides the vehicle to the facility. The processing unit 12 sets the searched-for facility as a transit point and changes the route so as to include the transit point, with the navigation mode placed in the background state. If the position of the vehicle is on a freeway, the processing unit 12 guides the vehicle to a next parking area such as a rest stop. If the position of the vehicle is on an ordinary road, the processing unit 12 sets a preset facility at which a washroom is generally available, such as, for example, a convenience store, a gas station, or a load-side station, as a transit point.

The icons 33a, 33b, and 33c described above are so-called purpose-specific icons that, after a switchover from manual driving to self-driving, respond to urgent demands for shopping, a meal, the use of a washroom, and the like. When the icon 33a, 33b, or 33c is touched, the relevant navigation function sets a related facility located closest to the current position as a transit point and changes the route so as to include the transient point, in the background state. It is also possible to display so-called surrounding facility icons, on a screen displayed on the display unit 21, that enable a user such as an occupant to search for a particular facility located in the vicinity of the travelling vehicle. When a surrounding facility icon is touched, the processing unit 12 displays related facilities on a map screen or displays them as a menu, enabling the user to select a desired facility.

After the desired facility has been selected, the processing unit 12 sets the desired facility as a transit point and changes the route so as to include the facility. As the surrounding facility icons are displayed on a screen on the display unit 21, search icons desired by a user such as an occupant can be selectively displayed. For example, the icon 33d is an icon to search for rental parking lots that are available for 24 hours a day. When the icon 33d is touched with an operating body, the processing unit 12 searches for rental parking lots that are located in the vicinity of the vehicle and are available for 24 hours a day and displays these rental parking lots. After a rental parking lot has been selected, the processing unit 12 sets the selected parking lot as a transit point. The icon 33e is an icon to search for gas stations. When the icon 33e is touched with an operating body, the processing unit 12 searches for gas stations located in the vicinity of the travelling vehicle and displays these gas stations. After a gas station has been selected, the processing unit 12 can set the selected gas station as a transit point. Similarly, the icon 33f is an icon to search for convenience stores. When the icon 33f is touched with an operating body, the processing unit 12 searches for a convenience store located in the vicinity of the travelling vehicle and displays these convenience stores. After a convenience store has been selected, the processing unit 12 can set the selected convenience store as a transit point.

The icons 33g and 33h, which are indicated by dashed lines, are off the screen on the display unit 21. They can be displayed on the screen by touching the scroll button 35b provided at the bottom of the display unit 21. Only a limited number of icons can be displayed on the screen at a time. If there are too many icons to fit to the screen, icons that are not displayed on the screen can be displayed by operating the scroll buttons 35a and 35b. The icon 33g represents a button to switch to the AV viewing mode, and the icon 33h represents a button to switch the displayed screen to a navigation-mode display. To prevent frequently used operation buttons, including icons, from being operated by mistake, they can be displayed so as to be larger than other buttons. Some operation buttons, such as icons, tend not to be operated for a predetermined time after they were operated last. These operation buttons can be hidden for the predetermined time. Then, other operation buttons such as icons can be displayed instead, enabling convenience to be improved. A display button 35 labeled OFF is provided at the upper-right corner of the displayed screen on the display unit 21. The display button 35 labeled OFF is an operation button to terminate the TV broadcast viewing mode that is currently in progress and display a navigation-mode screen (map display).

As illustrated in FIG. 2, the processing unit 12 decides whether any of the icons 33 (33a to 33h) displayed at the bottom of the screen, on which a news program is being broadcasted, on the display unit 21 in FIG. 3 has been selected (S14). If the processing unit 12 decides that any of the displayed icons 33 (33a to 33h) has been selected (the result in S14 is Yes), the processing unit 12 executes an operation related to the selected icon 33 (S15). If, for example, the icon 33c has been selected, the processing unit 12 sets the washroom facility closest to the current position of the vehicle as a transit point and changes the route so as to include the transit point, as described above. The processing unit 12 further decides whether another icon 33 has been selected (S16). If the processing unit 12 decides that another icon 33 has been selected (the result in S16 is Yes), the processing unit 12 executes an operation related to the selected icon 33 as described above (S16).

The processing unit 12 decides whether to make a switchover from the TV broadcast viewing mode (the navigation mode is in the background state) to the navigation mode (S17). If, for example, the operation button 35 labeled OFF, which is illustrated in FIG. 3, is touched, the processing unit 12 decides that a switchover to the navigation mode has been made (the result in S17 is Yes), the processing unit 12 changes the state of the navigation mode from background to foreground to switch to the navigation mode, in which the screen on the display unit 21 is changed from a TV broadcast screen to a map display screen based on the navigation function (S18).

Next, if any icon 33 has not been operated within a predetermined time, the processing unit 12 decides whether to terminate the use of the vehicle-mounted device 11 (S19). The processing unit 12 displays a touch operation field (not illustrated), which asks whether to terminate the use of the vehicle-mounted device 11. If the termination of the use of the vehicle-mounted device 11 is selected (the result in S19 is Yes), the processing unit 12 terminates the operation of the vehicle-mounted device 11. If the further use of the vehicle-mounted device 11 is selected, the processing unit 12 asks for another icon 33 to be selected (S14). In a case as well in which the screen is not operated within the predetermined time after a switchover to the navigation mode (in the foreground state), the processing unit 12 decides whether to terminate the use of the vehicle-mounted device 11, as described above (S20). The processing unit 12 displays a touch operation field (not illustrated), which asks whether to terminate the use of the vehicle-mounted device 11. If the termination of the use of the vehicle-mounted device 11 is selected, the processing unit 12 terminates the operation of the vehicle-mounted device 11. If the further use of the vehicle-mounted device 11 is selected, the processing unit 12 continues to keep the navigation mode in the foreground state.

As described above, with the vehicle-mounted device 11 used as the electronic device according to this embodiment, when the TV broadcast viewing mode or AV viewing mode, which is another operation mode other than the navigation mode, is enabled with the navigation mode placed in the background state and a video or the like is displayed on a screen on the display unit 21 while in a self-driving operation, operation buttons (such as icons) with which operations corresponding to the navigation mode are performed are also displayed. Therefore, when an operation button is touched while the above video or the like is being viewed, an operation corresponding to the navigation mode can be directly performed. Therefore, unlike a conventional case in which an operation to switch to the navigation mode needs to be performed before an operation corresponding to the navigation mode is performed, a desired operation corresponding to the navigation mode can be quickly executed without having to perform complex operations. For example, even while a TV broadcast is being viewed, when a search icon corresponding to the navigation mode, the search icon being displayed at the bottom of the video screen for a TV broadcast, is touched, the route can be changed to a selected desired facility, without having to perform an operation to switch to the navigation mode. Operation buttons are not limited to search icons; it is also possible to display other icons that ask for information such as traffic information. In addition, operation buttons displayed as ordinary text may be displayed, instead of icons.

Although, in this embodiment, operation buttons (such as icons) with which operations corresponding to the navigation mode are performed are displayed on a screen on which a video such as a TV broadcast is being viewed while in a self-driving operation, this embodiment is not limited to self-driving. For example, while in manual driving, when an occupant switches the screen displayed on the vehicle-mounted device from the navigation screen to the TV broadcast viewing screen, if operation buttons (such as icons) with which operations corresponding to the navigation mode are performed are also displayed on the TV broadcast viewing screen, an operation corresponding to the navigation mode (such as a search for a facility) can be directly executed quickly by touching the relevant operation button.

As described above, the electronic device according to the present invention displays, on the display operating unit, operation buttons with which operations corresponding to navigation functions, which operate according navigation information, when a video reproduced by the video reproducing unit is displayed on the display operating unit. Therefore, an operation corresponding to the navigation mode can be easily performed by touching the relevant operation button, without having to perform an operation to switch to the navigation mode. This makes the electronic device according to the present invention useful as an electronic device, such as, for example, a vehicle-mounted device, that has a display operating unit that displays an image based on navigation information or a video reproduced by a video reproducing unit and accepts an input made by touching a predetermined area with an operating body.

It is therefore intended that the foregoing detailed description be regarded as illustrative rather than limiting, and that it be understood that it is the following claims, including all equivalents, that are intended to define the spirit and scope of this invention.

What is claimed is:

1. An electronic device comprising:
a navigation unit configured to obtain navigation information about a vehicle in which the electronic device is mounted;
a video reproducing unit configured to reproduce a video from video information obtained from a video source;
a display operating unit configured to display an image based on the navigation information obtained by the navigation unit or a video reproduced by the video reproducing unit and to accept an input that is made by touching a predetermined area with an operating body; and
a display control unit configured to display at least one operation button on the display operating unit when the video reproduced by the video reproducing unit is displayed on the display operating unit, the at least one operation button configured to activate an operation corresponding to a navigation mode, which operates according to the navigation information.

2. The electronic device according to claim 1, wherein when the video reproduced by the video reproducing unit is displayed on the display operating unit, the navigation mode operates in a background.

3. The electronic device according to claim 2, wherein the video reproducing unit is structured as an audiovisual (AV) unit that is configured to reproduce a video from video information stored in a compact disc (CD) or a digital versatile disc (DVD), which is a storage medium, or as a television broadcast receiver that is configured to receive a television broadcast and reproduce a video.

4. The electronic device according to claim 3, wherein the at least one operation button is an icon that activates a predetermined program executed under a navigation function corresponding to the at least one operation button.

5. The electronic device according to claim 4, further comprising a proximity sensor configured to detect a proximity of the operating body to the display operating unit, wherein
when the proximity sensor detects the proximity of the operating body to within a predetermined range on the display operating unit, the display control unit is configured to display the at least one operation button on the display operating unit.

6. The electronic device according to claim 5, wherein the display control unit is configured to magnify an operation button that is frequently operated, the operation button being part of the at least one operation button, and configured to display the magnified operation button.

7. The electronic device according to claim 5, wherein after an operation button corresponding to the navigation mode has been operated by being touched with the operating body, the display control unit is configured to hide the operation button from the display operating unit until a predetermined time elapses.

8. The electronic device according to claim 1, wherein the video reproducing unit is structured as an AV unit that is configured to reproduce a video from video information stored in a CD or a DVD, which is a storage medium, or as a television broadcast receiver that is configured to receive a television broadcast and reproduce a video.

9. The electronic device according to claim 8, wherein the at least one operation button is an icon that activates a predetermined program executed under a navigation function corresponding to the at least one operation button.

10. The electronic device according to claim 9, further comprising a proximity sensor configured to detect a proximity of the operating body to the display operating unit, wherein
when the proximity sensor detects the proximity of the operating body to within a predetermined range on the display operating unit, the display control unit displays the at least one operation button on the display operating unit.

11. The electronic device according to claim 10, wherein the display control unit is configured to magnify an operation button that is frequently operated, the operation button being part of the at least one operation button, and to display the magnified operation button.

12. The electronic device according to claim 10, wherein after an operation button corresponding to the navigation mode has been operated by being touched with the operating body, the display control unit is configured to hide the operation button from the display operating unit until a predetermined time elapses.

13. The electronic device according to claim 1, wherein the at least one operation button is an icon that activates a predetermined program executed under a navigation function corresponding to the at least one operation button.

14. The electronic device according to claim 13, further comprising a proximity sensor configured to detect a proximity of the operating body to the display operating unit, wherein
when the proximity sensor detects the proximity of the operating body to within a predetermined range on the display operating unit, the display control unit is configured to display the at least one operation button on the display operating unit.

15. The electronic device according to claim 14, wherein the display control unit is configured to magnify an operation button that is frequently operated, the operation button being part of the at least one operation button, and to display the magnified operation button.

16. The electronic device according to claim 14, wherein after an operation button corresponding to the navigation mode has been operated by being touched with the operating body, the display control unit is configured to hide the operation button from the display operating unit until a predetermined time elapses.

17. The electronic device according to claim 1, further comprising a proximity sensor configured to detect a proximity of the operating body to the display operating unit, wherein
when the proximity sensor detects the proximity of the operating body to within a predetermined range on the display operating unit, the display control unit is configured to display the at least one operation button on the display operating unit.

18. The electronic device according to claim 17, wherein the display control unit is configured to magnify an operation button that is frequently operated, the operation button being part of the at least one operation button, and to display the magnified operation button.

19. The electronic device according to claim 17, wherein after an operation button corresponding to the navigation mode has been operated by being touched with the operating body, the display control unit is configured to hide the operation button from the display operating unit until a predetermined time elapses.

20. The electronic device according to claim 1, wherein the display control unit is configured to magnify an operation button that is frequently operated, the operation button being part of the at least one operation button, and to display the magnified operation button.
